(19) United States
(12) Patent Application Publication
(10) Pub. No.: US 2017/0308912 A1
(43) Pub. Date: Oct. 26, 2017

(54) Method for a Consumer Rewards/Incentive Program

(71) Applicants: Justin McConnell, Fairfax Station, VA (US); Margaret McConnell, Fairfax Station, VA (US)

(72) Inventors: Justin McConnell, Fairfax Station, VA (US); Margaret McConnell, Fairfax Station, VA (US)

(21) Appl. No.: 15/137,995

(22) Filed: Apr. 25, 2016

(51) Int. Cl. G06Q 30/02

(52) U.S. Cl. CPC G06Q 30/0201

(57) ABSTRACT

A social review platform which generates confidential review content for a business by compensating customers for their valuable review. The platform is managed by a remote server and is accessible by a plurality of customer accounts through a corresponding personal computing (PC) device. Goods-and-services (GAS)-provided information associated to the merchant account is displayed to each of the customer accounts through the corresponding PC device. Then each of the customer accounts is prompted to provide feedback information in relation to the GAS-provided information. Upon receiving feedback information from an arbitrary account from the customer accounts, a credit amount is transferred from a merchant credit balance to a customer credit balance of the arbitrary account, i.e. compensation for his/her input. Finally, the gathered feedback information of the arbitrary account is provided to the merchant account.

### FIELD OF THE INVENTION

The present invention relates generally to a method for a rewards program. More specifically, the present invention is method for a rewards program for a multitude of businesses which allows customer participants to confidentially rate and review businesses, products, and services. The customer participants are compensated for their input. Simultaneously, the participating businesses are provided with insightful, private customer feedback that may be used to change or improve their products and/or services.

### BACKGROUND OF THE INVENTION

Businesses rely heavily on their reputation. Finding out exactly what that reputation may be, as well as letting others know of positive or negative experiences, can be difficult with the presently available resources the consumer has access too. Additionally, with current resources, it is difficult to obtain unbiased reviews and comments from customers. Current review platforms publically publish customer reviews and provide the public with an insight on the quality of goods and/or services provided by business being reviewed. The driving mechanism behind the current review platforms is also its limiting factor. Because all of the customer reviews are published, the content is therefore susceptible to various biases and targeted slander. As a result, the reviews and ratings cannot be trusted to a high degree. Alternatively, any review platform that does not publish its content is unsuccessful because of the lack of a driving mechanism, the incentive essentially.

The present invention is a method for a review platform that produces reliable feedback information by incentivizing both the businesses and customers without publishing review content to the public. The present invention is a free mobile phone application that is available a variety of devices and operating systems. The application enables the member to confidentially rate businesses, services and products like a ‘secret shopper’ and in turn receive monetary gain. These ratings are only seen by the business and do not go out to the general public, giving the business or service provider insightful, private information to enhance, change or take immediate action to improve the quality or services of their business.

### BRIEF DESCRIPTION OF THE DRAWINGS

FIG. 1 is a system diagram of the present invention.

FIG. 2 is a flowchart illustrating the overall process of the present invention.

FIG. 3 is a flowchart illustrating the sub-steps necessary for ensuring the merchant credit balance of the merchant account contains enough credits to access feedback information.

FIG. 4 is a flowchart illustrating the sub-steps necessary to display each of the merchant accounts to each of the customer accounts based on physical proximity.

FIG. 5 is a flowchart illustrating the sub-steps necessary for generating an overview report for the merchant account with a plurality of feedback information.

FIG. 6 is a flowchart illustrating the sub-steps necessary for executing the overall process for each of the customer accounts and each of the merchant accounts.

FIG. 7 is a flowchart illustrating the sub-steps necessary for receiving quality ratings as the feedback information.

FIG. 8 is a flowchart illustrating the sup-steps necessary for receiving a set of responses for a survey questionnaire as the feedback information.

FIG. 9 is a flowchart illustrating the sub-steps necessary for receiving a digital image as the feedback information.

FIG. 10 is a flowchart illustrating the sub-steps necessary for receiving a purchase receipt as the feedback information.

FIG. 11 is a flowchart illustrating the sub-steps necessary for allowing the merchant account to replenish the merchant credit balance.

FIG. 12 is a flowchart illustrating the sup-steps necessary for awarding an arbitrary account based on first generation association.

### DETAIL DESCRIPTIONS OF THE INVENTION

All illustrations of the drawings are for the purpose of describing selected versions of the present invention and are not intended to limit the scope of the present invention.

The present invention is a system and method for a rewards and customer review program. More specifically, the present invention is a loyalty program integrated into a customer review program which enables individuals to confidentially rate and review businesses, products, and services similar to a ‘secret shopper’ and in turn receive payment for their valuable input. The ratings and reviews are not published and are only available to the businesses or service providers being reviewed. This confidential information may be used by the businesses to enhance the quality of their products and/or services.

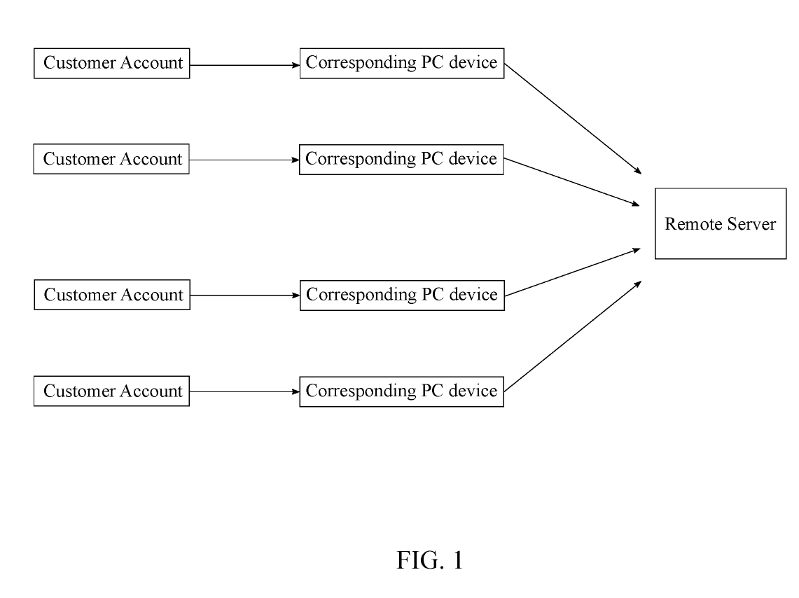

The method of the present invention is a software application executed by a computing device. More specifically, the present invention is a software application for a smart phone, and is hosted on an at least one remote server. Referring to FIG. 1, the remote server manages a plurality of customer accounts, an at least one merchant account, and an administrator account (Step A). The remote server provides significant amounts of data storage to be used by the present invention for the storage of customer information, advertisement content, reviews, ratings, and other pertinent information. Each of the customer accounts is associated with a customer credit balance and a corresponding personal computing (PC) device (Step B). The customer credit balance is a record which keeps track of the number of credits awarded to the individual associated with customer account. Credits refers to award points used in the present invention. These credits act as a placeholder that may be traded in for cash, special discounts from business, and other similar prizes/awards. In one embodiment of the present invention, upon registration each of the customer accounts receives a physical credit card. The present invention pays each of the customer accounts through the credit card.

The corresponding PC device runs the software application and is the means by which the individual interacts with the present invention. The corresponding PC device may be virtually any modern computing device which possesses an Internet connection and a user interface. Types of devices that may be used for the corresponding PC device include, but is not limited to, desktop computers, laptop computers, smart phones, and tablet computers. Although, the preferred device is a smart phone. The present invention is preferably offered to the individual for free and is compatible with a variety of smart phones and operating systems. In order to register, the individual simply downloads the application and creates a customer account. Registration requires personal information from the individual such as name, email, phone number, age, sex, and other pertinent information.

Similar to each of the customer accounts, the merchant account is associated with a merchant credit balance that manages and records the number of credits available to the business associated with the merchant account. When the merchant account is initially created for a business, the business inputs goods-and-services (GAS)-provided information (Step C). The GAS-provided information is associated with the merchant account and include information such as advertisements, survey questionnaire, physical address, contact information, business name, number of employees, and other pertinent information about business. Additionally, the merchant account is preferably provided with an initial credit amount as a free-trial offer.

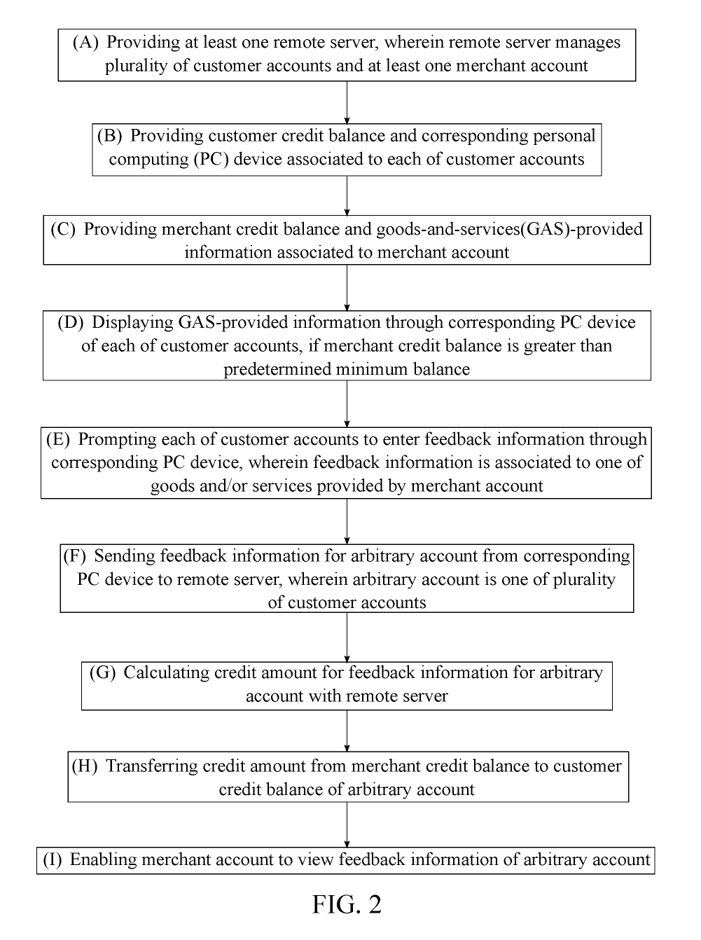

In general, the present invention is a social marketing platform that allows members to rate and provide honest feedback to any type of business, service, or product. Referring to FIG. 2, the overall process of the present invention is disclosed in relation to an arbitrary account and the single merchant account, wherein the arbitrary account is one of the customer accounts. The overall process beings with displaying GAS-provided information through the corresponding PC device of each of the customer accounts. This occurs only if the merchant credit balance is greater than a predetermined minimum balance, essentially a check to make sure the merchant account paid for the services provided by the present invention (Step D). This step displays advertisements and other similar information of the merchant account to each of the customer accounts, providing the merchant account with a marketing service. Next, each of the customer accounts is prompted to enter feedback information through the corresponding PC device, wherein the feedback information is associated to one of goods and/or services provided by the merchant account (Step C). In general, each of the customer accounts is provided the option to rate or review the business associated with the merchant account at any time. Upon receiving feedback information from the arbitrary customer account, the feedback information is sent from the corresponding PC device to the remote server for storage and analysis (Step D).

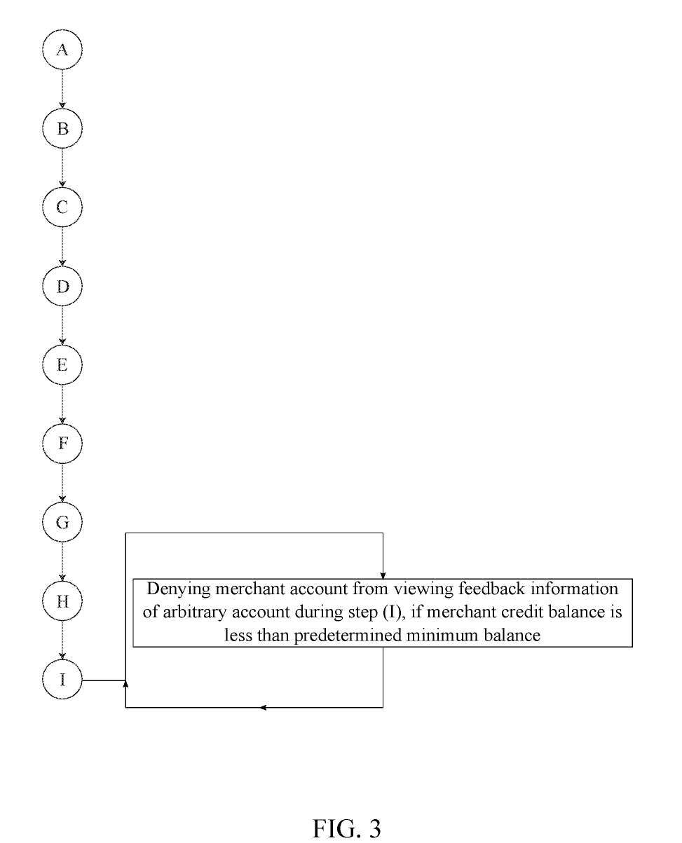

In response to receiving feedback information, the present invention awards the arbitrary account. First, a credit amount is calculated for the type of feedback information for the arbitrary account with the remote server (Step G). Different types of feedback information are rewarded with different levels of compensation. For example, a simple rating review will yield 20 points while filling out a survey will yield 40 points; credit amount for different feedback information may vary and is subject to change. Next, the credit amount is transferred from the merchant credit balance to the customer credit balance of the arbitrary customer account (Step H). Finally, the last step is enabling the merchant account to view the feedback information of the arbitrary account (Step I). At this point, the present invention runs another check on the merchant account and determines if a subscription is still active. Referring to FIG. 3, if the merchant credit balance is less than the predetermined minimum balance, then the merchant account is denied from viewing the feedback information of the arbitrary account.

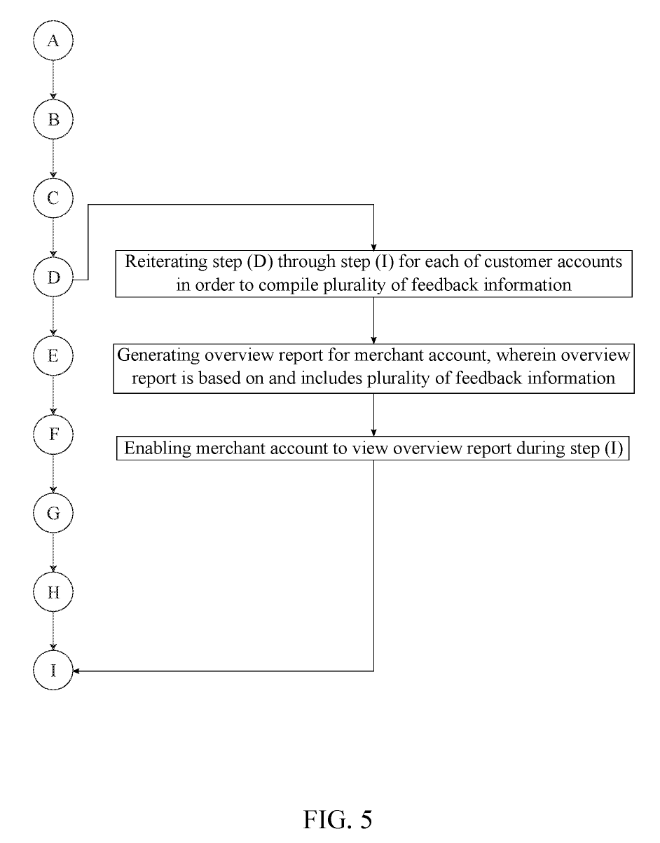

Referring to FIG. 5, the present invention is executed for the plurality of customer accounts in order to compile a comprehensive review of the business associated with the merchant account. More specifically, Step D through Step I are reiterated for each of the customer accounts in order to compile a plurality of feedback information. The plurality of feedback information is then used to generate an overview report for the merchant account, wherein the overview report is based on and includes the plurality of feedback information. Additionally, data from the plurality of feedback information is grouped and statistically analyzed to better represent the communities view of the merchant account. The present invention enables the merchant account to view the overall report during Step I.

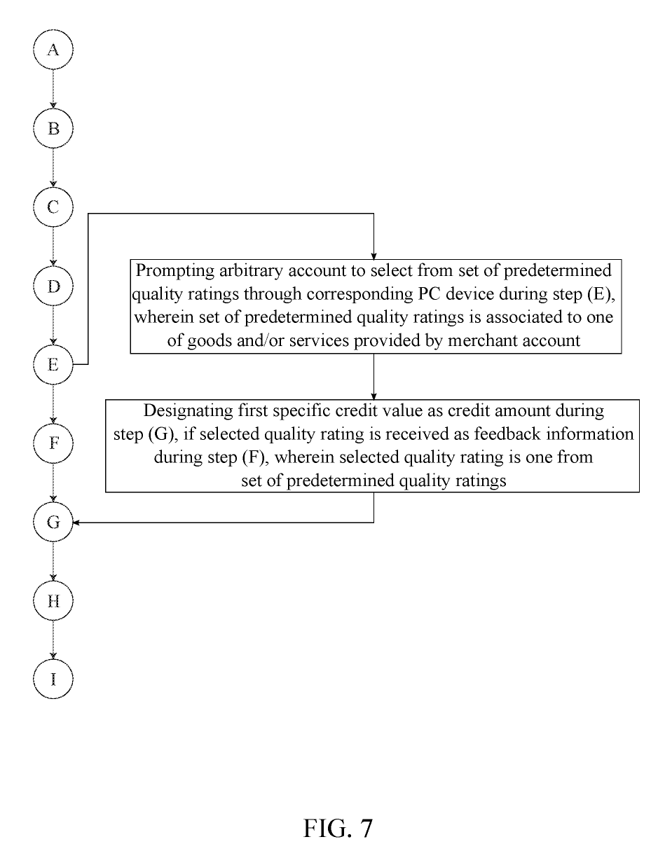

Referring to FIG. 7, one type of feedback information is a simple rating. During Step E, the arbitrary customer account is prompted to select from a set of predetermined quality ratings, wherein the set of predetermined quality ratings is associated with one of goods and/or services provided by the merchant account. In one embodiment of the present invention, the set of predetermined quality ratings is five different faces describing a satisfaction level. The set of predetermined quality ratings range from a frown face reflecting a lowermost satisfaction level to a smiley face reflecting a highest satisfaction level, with three other variations in between. In another embodiment, each within the set of predetermined quality ratings is a star rating ranging from one star to five stars. In addition, the arbitrary account may also be prompted to provide a written response which describes his or her experience in relation to the goods and/or services provided by the merchant account.

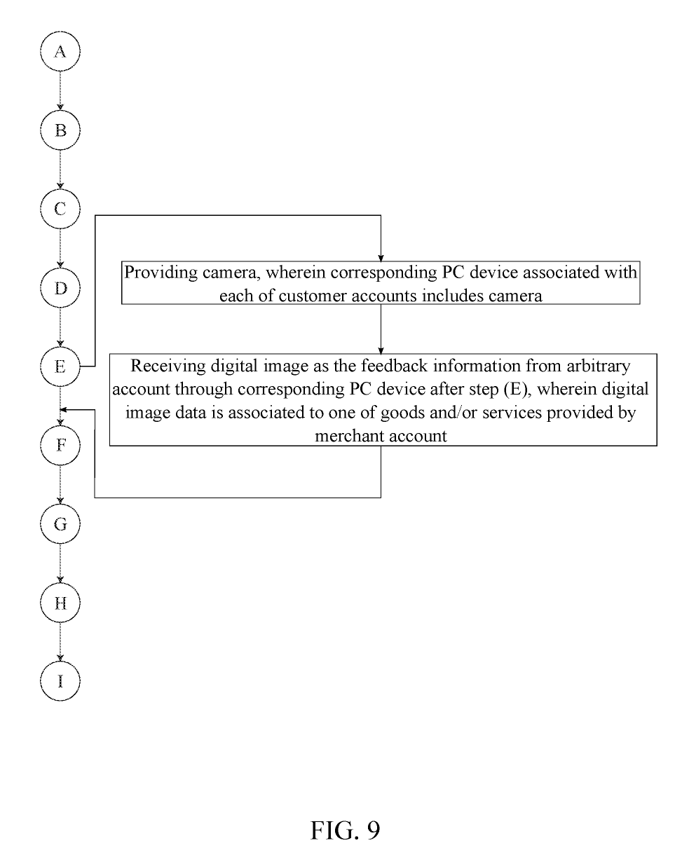

If a selected quality rating is received as the feedback information during Step F, then a first specific credit value is designated as the credit amount during Step G; the selected quality rating is one from the set of predetermined quality ratings. The first specific credit value is a value set by the administrator account and is the reward for providing a rating as the feedback information. It is preferred that the first specific credit value is relatively low when compared to other rewards as it does not require purchase of product and does not contain much detail. Although the first specific credit may be changed by the administrator account at incremental times. Referring to FIG. 9, the present invention also allows the arbitrary account to submit an image alongside the selected quality rating. This feature is only available if a camera is included in the corresponding PC device. After Step E, the present invention may receive a digital image as the feedback information from the arbitrary account through the corresponding PC device. The digital image may be of the company that the arbitrary account is reviewing, although it is preferred that the digital image is associated to one of goods and/or services provided by the merchant account. This allows each of the customer accounts the ability to provide visual justification for their selected quality rating.

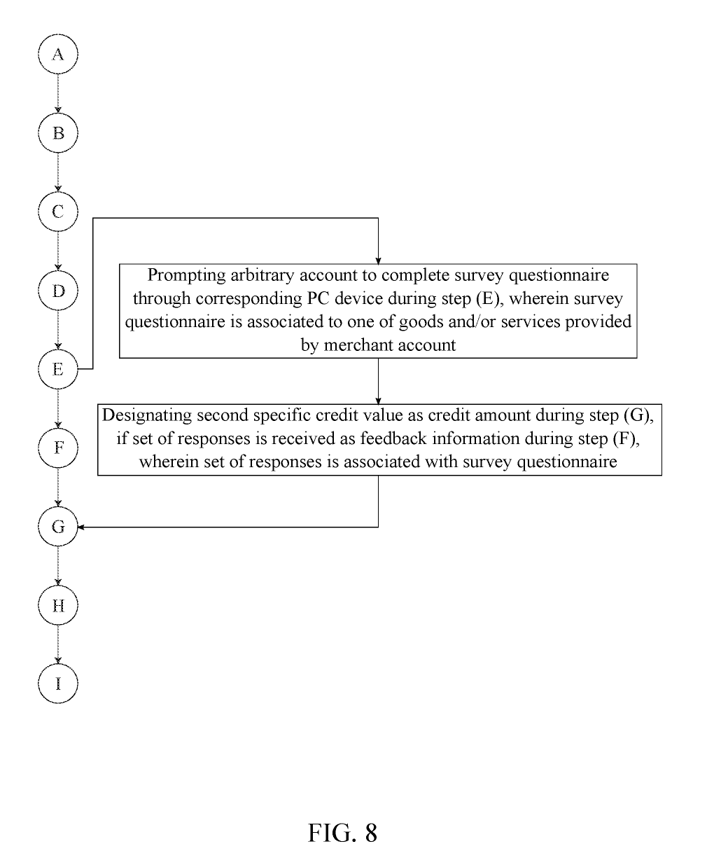

Referring to FIG. 8, another type of feedback information includes responses to a survey questionnaire, wherein the survey questionnaire is associated to one of goods and/or services provided by the merchant account. For example, if one of goods and/or services provided by the merchant account is sea food, then the survey questionnaire would contain questions about the quality, the freshness, and or the pricing of the sea food. The present invention allows the merchant account to create and customize the survey questionnaire, thus providing a means for easily identifying regions of the business in need of improvement.

During Step E, the arbitrary customer account is prompted to complete the survey questionnaire provided by the merchant account. The questionnaire may be implemented in a variety of forms including, but not limited to, free responses, multiple choice, and other similar response mediums. The number, the type, and quality of questions is subject to change based on the preferences and needs of the merchant account. If a set of responses is received as the feedback information during Step F, then a second specific credit value is designated as the credit amount during Step G; the set of responses is associated with the survey questionnaire. The second specific value is a value set by the administrator account and is the reward for answering a survey questionnaire. It is preferred that the second specific credit is relatively medium when compared to other rewards as it requires time to fill out and provides relatively valuable information to the merchant account. Although the second specific credit may be changed by the administrator account at incremental times.

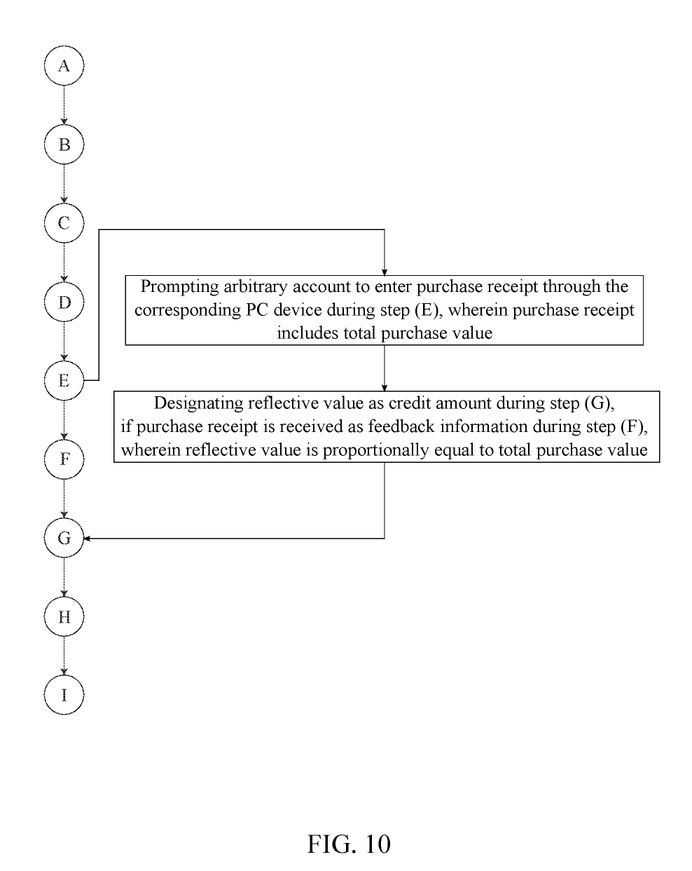

Referring to FIG. 10, another type of feedback information is proof of purchase, essentially a loyalty feature. Proof of purchase indicates that the customer account purchased one of the goods and/or services provided by the merchant account. During Step E the arbitrary account is prompted to enter a purchase receipt through the corresponding PC device, wherein the purchase receipt includes a total purchase value. The purchase receipt may be entered through a variety of means including, but not limited to, taking a picture of the purchase receipt, scanning a barcode of the purchase receipt, entering a confirmation number from the purchase receipt, and other similar methods. If the purchase receipt is received as the feedback information during Step F, a reflective value is designated as the credit amount during Step G. The reflective value is proportionally equal to the total purchase value; the specific proportion is subject to change. For example, in one embodiment of the present invention, one dollar yields 10 credits. In other words, the larger the total purchase value, the more credits are rewarded to the arbitrary account.

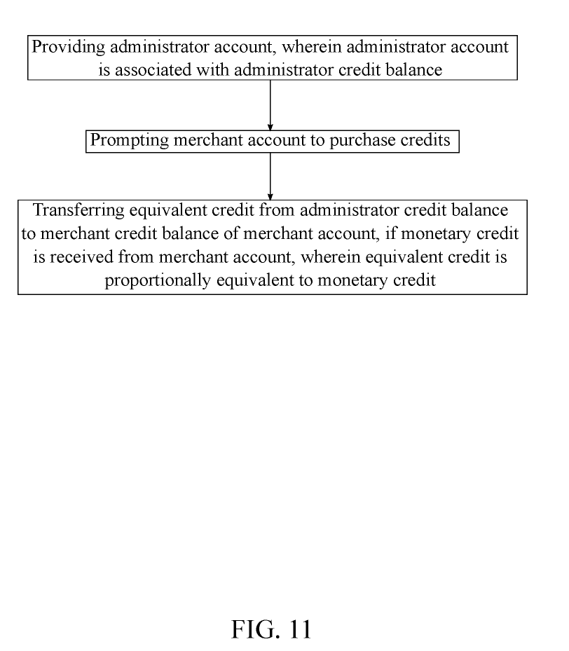

Referring to FIG. 11, at anytime throughout the overall process of the present invention, the merchant account is able to purchase credits to continue subscribing to the services of the present invention. In particular, the merchant account is prompted to purchase credits at anytime. If monetary credit is received from the merchant account, then equivalent credit is transferred from an administrator credit balance to the merchant credit balance of the merchant account. The equivalent credit is proportionally equivalent to the monetary credit and the conversion factor is set by the administrator account. In one embodiment of the present invention, each credit is worth 1.5 cents. This allows the merchant account to continue to advertise and receive feedback information with the present invention. The required subscription to the services of the present invention in conjunction with the feedback information received from the present invention creates incentive and the driving force for the merchant account and each of the customer accounts.

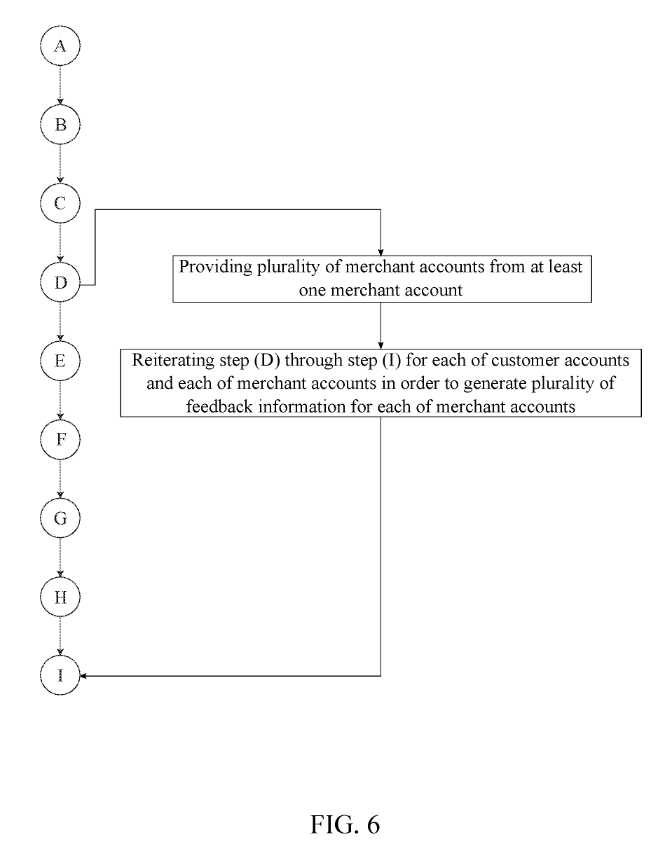

Referring to FIG. 6, in order to create a social marketing platform, the overall process is executed for a plurality of merchant accounts from the at least one merchant account. More specifically, Step D through Step I are reiterated for each of the customer accounts and each of the merchant accounts in order to generate the plurality of feedback information for each of the merchant accounts. With the present invention, each of the merchant accounts receives valuable and confidential feedback information, that then may be used to improve and change their respective goods and/or services to comply with customer needs and preferences. Additionally, the gathered information is also used to identify an overall view on various industries, for example Mexican restaurants. In particular, the present invention continuously generates and updates an industry portfolio for the plurality of merchant accounts that is based on the plurality of feedback information for each of merchant accounts. Each of the merchant accounts are enabled to view portions of the industry portfolio which are related to his or her field of business.

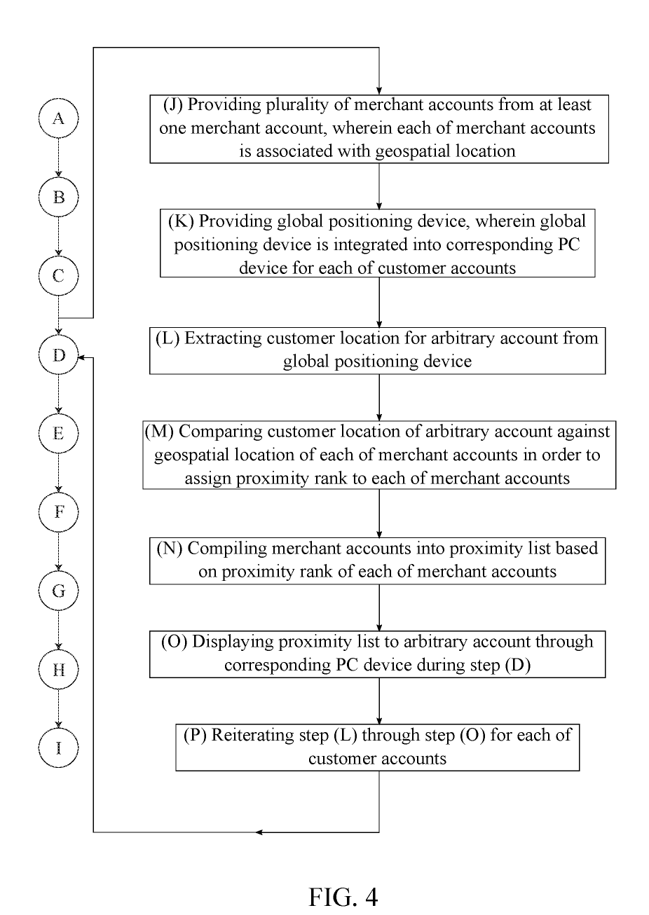

Referring to FIG. 4, the present invention presents the plurality of merchant accounts to the each of the customer accounts based on physical proximity. During the initial registration process, each of the plurality of merchant accounts provides a geospatial location that the business is associated with (Step J). Similarly, the corresponding PC device for each of the customer accounts includes a global positioning device (Step K). The present invention utilizes the aforementioned locations to display only the closest merchant accounts to each of the customer accounts. More specifically, first the present invention extracts a customer location for the arbitrary account from the global positioning device (Step L). Next, the customer location of the arbitrary account is compared against the geospatial location of each of the merchant accounts in order to assign a proximity rank to each of the merchant accounts (Step M). Merchant accounts closest to the arbitrary account are assigned a high rank and merchant accounts furthest from the arbitrary account are assigned a low rank. Resultantly, the present invention compiles the merchant accounts into a proximity list based on the aforementioned proximity rank of each of the merchant account (Step N). The proximity list is then displayed to the arbitrary account through the corresponding PC device during Step D. In general, this shows the arbitrary account the closest businesses that participate in the present invention. Step L through Step O are repeated for each of the customer accounts.

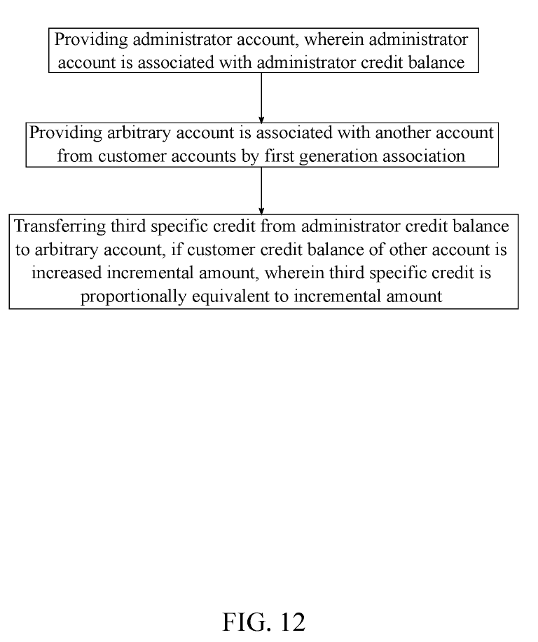

Referring to FIG. 12, another main way that customer accounts can earn credits is through the introduction of new customers and new businesses to the present invention. Referring a business to the present invention will yield additional credits. Similarly, referring a customer to the present invention will yield additional credits as well. Additionally, the present invention allows customer accounts to grow their team three generations in size and benefit from their total team performance. More specifically, when the arbitrary account refers another customer to the present invention, the arbitrary account is then associated to an another account from the customer accounts by a first generation association, wherein the other account is the referred customer. This allows the arbitrary account to benefit from the earning generated by the other account. More specifically, if the customer credit balance of the other account is increased an incremental amount, then a third specific credit is transferred from the administrator account to the arbitrary account. The third specific credit is proportionally equivalent to the incremental amount. In the preferred embodiment, the present invention allows for up to three generation associations. In other words, the arbitrary account receives credit every time a friend, any of their friends, or any of their friends, provide feedback information through the present invention. This features serves as incentive to refer as many friends and businesses, thus growing the social platform.

Although the invention has been explained in relation to its preferred embodiment, it is to be understood that many other possible modifications and variations can be made without departing from the spirit and scope of the invention as hereinafter claimed.

What is claimed is:

1. A method for a consumer rewards/incentive program comprises the steps of:
(A) providing an at least one remote server, wherein the remote server manages a plurality of customer accounts and an at least one merchant account;
(B) providing a customer credit balance and a corresponding personal computing (PC) device associated to each of the customer accounts;
(C) providing a merchant credit balance and goods-and-services (GAS)-provided information associated to the merchant account;
(D) displaying GAS-provided information through the corresponding PC device of each of the customer accounts, if the merchant credit balance is greater than a predetermined minimum balance;
(E) prompting each of the customer accounts to enter feedback information through the corresponding PC device, wherein the feedback information is associated to one of goods and/or services provided by the merchant account;
(F) sending the feedback information for an arbitrary account from the corresponding PC device to the remote server, wherein the arbitrary account is one of the plurality of customer accounts;
(G) calculating a credit amount for the feedback information for the arbitrary account with the remote server;
(H) transferring the credit amount from the merchant credit balance to the customer credit balance of the arbitrary account; and
(I) enabling the merchant account to view the feedback information of the arbitrary account.

2. The method for a consumer rewards/incentive program as claimed in claim 1 comprises the steps of:
denying the merchant account from viewing the feedback information of the arbitrary account during step (I),
if the merchant credit balance is less than the predetermined minimum balance.

3. The method for a consumer rewards/incentive program as claimed in claim 1 comprises the steps of:
(J) providing a plurality of merchant accounts from the at least one merchant account, wherein each of the merchant accounts is associated with a geospatial location;
(K) providing a global positioning device, wherein the global positioning device is integrated into the corresponding PC device for each of the customer accounts;
(L) extracting a customer location for the arbitrary account from the global positioning device;
(M) comparing the customer location of the arbitrary account against the geospatial location of each of the merchant accounts in order to assign a proximity rank to each of the merchant accounts;
(N) compiling the merchant accounts into a proximity list based on the proximity rank of each of the merchant accounts;
(O) displaying the proximity list to the arbitrary account through the corresponding PC device during step (D); and
(P) reiterating step (L) through step (O) for each of the customer accounts.

4. The method for a consumer rewards/incentive program as claimed in claim 1 comprises the steps of:
reiterating step (D) through step (I) for each of the customer accounts in order to compile a plurality of feedback information;
generating an overview report for the merchant account, wherein the overview report is based on and includes the plurality of feedback information; and
enabling the merchant account to view the overview report during step (I).

5. The method for a consumer rewards/incentive program as claimed in claim 1 comprises the steps of:
providing a plurality of merchant accounts from the at least one merchant account; and
reiterating step (D) through step (I) for each of the customer accounts and each of the merchant accounts in order to generate a plurality of feedback information for each of the merchant accounts.

6. The method for a consumer rewards/incentive program as claimed in claim 1 comprises the steps of:
prompting the arbitrary account to select from a set of predetermined quality ratings through the corresponding PC device during step (E), wherein the set of predetermined quality ratings is associated to one of goods and/or services provided by the merchant account; and
designating a first specific credit value as the credit amount during step (G),
if a selected quality rating is received as the feedback information during step (F),
wherein the selected quality rating is one from the set of predetermined quality ratings.

7. The method for a consumer rewards/incentive program as claimed in claim 1 comprises the steps of:
prompting the arbitrary account to complete a survey questionnaire through the corresponding PC device during step (E), wherein the survey questionnaire is associated to one of goods and/or services provided by the merchant account; and
designating a second specific credit value as the credit amount during step (G),
if a set of responses is received as the feedback information during step (F),
wherein the set of responses is associated with the survey questionnaire.

8. The method for a consumer rewards/incentive program as claimed in claim 1 comprises the steps of:
providing a camera, wherein the corresponding PC device associated with each of the customer accounts includes the camera; and
receiving a digital image as the feedback information from the arbitrary account through the corresponding PC device after step (E), wherein the digital image data is associated to one of goods and/or services provided by the merchant account.

9. The method for a consumer rewards/incentive program as claimed in claim 1 comprises the steps of:
prompting the arbitrary account to enter a purchase receipt through the corresponding PC device during step (E), wherein the purchase receipt includes a total purchase value; and
designating a reflective value as the credit amount during step (G),
if the purchase receipt is received as the feedback information during step (F),
wherein the reflective value is proportionally equal to the total purchase value.

10. The method for a consumer rewards/incentive program as claimed in claim 1 comprises the steps of:
providing an administrator account, wherein the administrator account is associated with an administrator credit balance;
prompting the merchant account to purchase credits; and
transferring equivalent credit from the administrator credit balance to the merchant credit balance of the merchant account,
if monetary credit is received from the merchant account,
wherein the equivalent credit is proportionally equivalent to the monetary credit.

11. The method for a consumer rewards/incentive program as claimed in claim 1 comprises the steps of:
providing an administrator account, wherein the administrator account is associated with an administrator credit balance;
providing the arbitrary account is associated with an another account from the customer accounts by a first generation association; and
transferring a third specific credit from the administrator credit balance to the arbitrary account,
if the customer credit balance of the other account is increased an incremental amount,
wherein the third specific credit is proportionally equivalent to the incremental amount.
